(19) United States
(12) Patent Application Publication
(10) Pub. No.: US 2017/0077698 A1
(43) Pub. Date: Mar. 16, 2017

(54) EMBEDDED POWER CONVERTING DEVICE AND POWER CONVERSION SYSTEM USING SAME

(71) Applicant: DELTA ELECTRONICS, INC., Taoyuan City (TW)

(72) Inventor: CHIH-YEN LIU, Taoyuan City (TW)

(21) Appl. No.: 15/047,341

(22) Filed: Feb. 18, 2016

(30) Foreign Application Priority Data
Sep. 16, 2015 (TW) 104130556

(51) Int. Cl. H02J 1/00; H02M 7/04; H02J 7/00

(52) U.S. Cl. CPC H02J 1/00; H02J 7/0044; H02M 7/04

(57) ABSTRACT

A power conversion system is disclosed. The power conversion system comprises a portable electronic device and an embedded power converting device. The portable electronic device comprises a connecting terminal and a first control unit. The embedded power converting device is partially embedded in a closed structure and configured to convert an input voltage into a DC voltage, and comprises a socket and a second control unit. The socket is partially exposed outside the closed structure for allowing the connecting terminal to be inserted therein. When the connecting terminal is inserted in the socket, the second control unit is in communication with the first control unit to acquire a required DC charging voltage for the portable electronic device and the embedded power converting device outputs a DC voltage equal to the required DC charging voltage to the connecting terminal through the socket.

### FIELD OF THE INVENTION

The present invention relates to a power converting device, and more particularly to an embedded power converting device and a power conversion system using the same.

### BACKGROUND OF THE INVENTION

With the development of science and technology, a variety of portable electronic devices such as mobile phones, notebook computers, digital cameras or personal digital assistant (PDA) are released and bring convenience to people's life. However, since most portable electronic devices require DC voltage as the power source to operate, a power converting device needs to be coupled with the portable electronic device so as to convert AC voltage provided from utility power source or power distribution box of a building to a specific DC voltage. Therefore, the specific DC voltage can be supplied to the portable electronic device.

The portable electronic devices have various types, so that the power converting devices coupled with the portable electronic devices also have various types to meet different required DC voltages of the portable electronic devices or the connecting terminals of the portable electronic devices. Besides, the power converting device requires an AC power cable to receive the AC power no matter whether the power converting device is installed in the portable electronic device or not. Under this circumstance, if a user has more portable electronic devices, he also has more power converting devices and AC power cables. These power converting devices and AC power cables are distributed around and may cause bad impact to the user. First, using the AC power cable may increase the risk of electric wire fire and electric shock, and using the power converting device may make the user exposed in an environment of electromagnetic interference easily and be harmful to the user. Further, if the power converting device is installed in the portable electronic device, the volume and weight of the portable electronic device are increased, and the temperature of the portable electronic device is increased. Also, the energy conversion efficiency of the portable electronic device is reduced and electromagnetic interference of the portable electronic device fails to be suppressed. Yet if the power converting device is located outside the portable electronic device, man-caused damage on the outward appearance and breakdown of the power converting device occur more easily and cause risks of electric shock or fires. Therefore, with respect to the power converting device located outside the portable electronic device, the limitations and requirements of the safety regulations and electromagnetic interference specifications are stricter. As a result, the cost of the power converting device increases.

As a result, an embedded power converting device and a power conversion system using the same are provided in order to overcome the above drawbacks encountered by the prior arts.

### SUMMARY OF THE INVENTION

An object of the present invention provides an embedded power converting device and a power conversion system using the same. The embedded power converting device is partially embedded within a closed structure and configured to convert an input voltage transmitted from the closed structure into a DC voltage so as to charge the portable electronic device with the DC voltage. Therefore, the electric wire fire and electric shock can be prevented by using the embedded power converting device, and the electromagnetic interference can be suppressed by the closed structure. In addition, the volume and weight of the portable electronic device can be decreased by using the embedded power converting device, the temperature of the portable electronic device can be decreased, and the energy conversion efficiency of the portable electronic device can be increased. Furthermore, the cost of the power conversion system or the embedded power converting device can be reduced.

In accordance with an aspect of the present invention, a power conversion system is provided. The power conversion system comprises at least one portable electronic device and an embedded power converting device. The at least one portable electronic device comprises a connecting terminal and a first control unit. The embedded power converting device is partially embedded in a closed structure and configured to convert an input voltage into a DC voltage, and comprises at least one socket and a second control unit. The socket is partially exposed outside the closed structure for allowing the connecting terminal to be inserted therein. When the connecting terminal is inserted in the socket, the second control unit is in communication with the first control unit to acquire a required DC charging voltage for the portable electronic device and the embedded power converting device outputs a DC voltage equal to the DC charging voltage to the connecting terminal through the socket.

In accordance with another aspect of the present invention, an embedded power converting device is provided. The embedded power converting device is partially embedded in a closed structure and used to convert an input voltage into a DC voltage, and comprises at least one socket and a second control unit. The at least one socket is partially exposed outside the closed structure for allowing a connecting terminal of a portable electronic device to be inserted therein. When the connecting terminal is inserted in the socket, the second control unit is in communication with the first control unit to acquire a required DC charging voltage for the portable electronic device, and the embedded power converting device outputs a DC voltage equal to the required DC charging voltage to the connecting terminal through the socket.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a power conversion system according to a first embodiment of the present invention;

FIG. 2 is a circuit block diagram showing a portable electronic device and an embedded power converting device of FIG. 1;

FIG. 3 schematically illustrates a connecting cable of FIG. 1;

FIG. 4 schematically illustrates the inner structure of a socket of FIG. 3; and

FIG. 5 is a circuit block diagram illustrating a portable electronic device and an embedded power converting device of a power conversion system according to a second embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

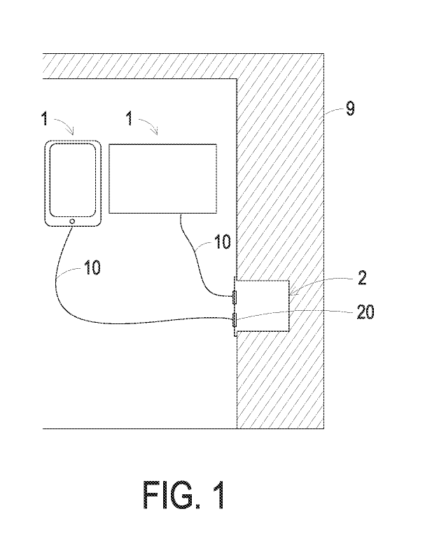

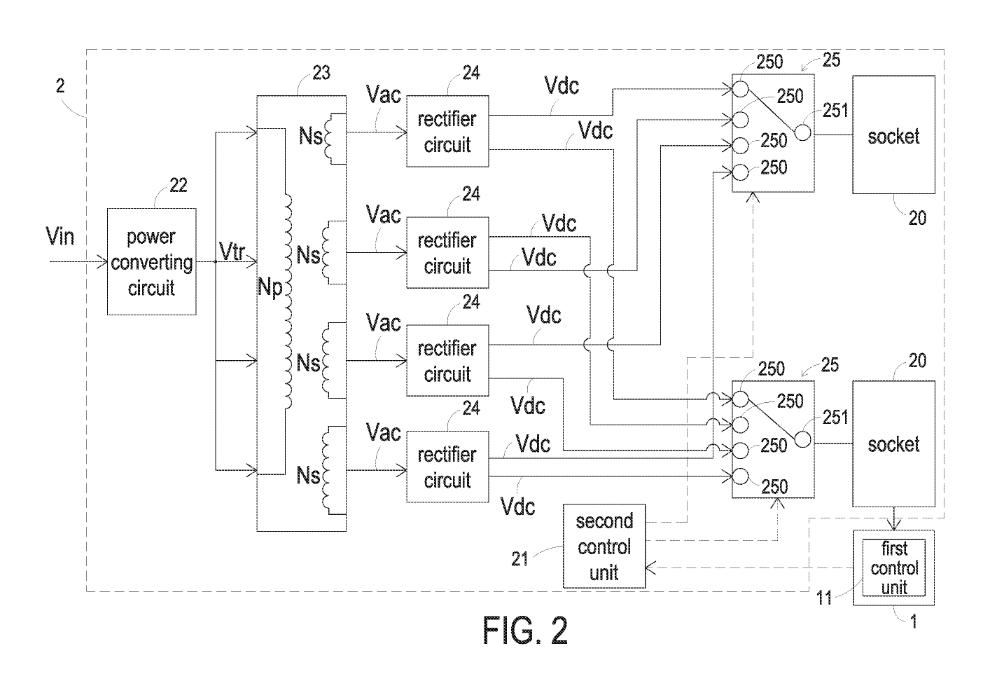

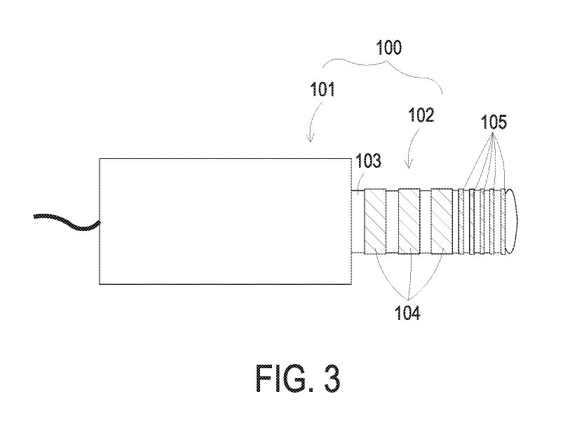

Please refer to FIGS. 1, 2 and 3. FIG. 1 is a schematic perspective view illustrating a power conversion system according to a first embodiment of the present invention, FIG. 2 is a circuit block diagram showing a portable electronic device and an embedded power converting device of FIG. 1, and FIG. 3 schematically illustrates a connecting cable of FIG. 1. As shown in FIGS. 1, 2 and 3, the power conversion system comprises at least one portable electronic device 1 and an embedded power converting device 2. Taking an example as shown in FIG. 1, the power conversion system comprises two portable electronic devices 1, and the two portable electronic devices 1 include but not limited to mobile phones, notebook computers, digital cameras and personal digital assistants. Each portable electronic device 1 comprises a connecting cable 10 and a first control unit 11 (as shown in FIG. 2). One end of the connecting cable 10 is electrically connected with the portable electronic device 1, and the other end of the connecting cable 10 has a connecting terminal 100 (as shown in FIG. 3). The connecting terminal 100 comprises a holding portion 101 and an inserting portion 102. The holding portion 101 is made of an insulation material and configured for allowing the user to hold thereon. The inserting portion 102 is physically connected with the holding portion 101 and electrically connected with a conducting wire (not shown) inside the connecting cable 10.

The embedded power converting device 2 is at least partially embedded in a closed structure 9. The closed structure 9 includes but not limited to a wall or a power distribution box. The closed structure 9 can provide an input voltage Vin (as shown in FIG. 2). For example, when the closed structure 9 is the wall as shown in FIG. 1, the input voltage Vin is an AC voltage provided from utility power source. The embedded power converting device 2 receives the input voltage Vin and converts the input voltage Vin into at least one DC voltage Vdc so as to charge the at least one portable electronic device 1 with the DC voltage Vdc. The embedded power converting device 2 comprises at least one socket 20 and a second control unit 21. Taking an example as shown in FIG. 1, the embedded power converting device 2 comprises two sockets 20, and the two sockets 20 are partially exposed outside the closed structure 9, respectively. The structures of the sockets 20 are mated with the structures of the inserting portions 102 of the connecting terminals 100 of the connecting cables 10, respectively. The inserting portion 102 of the connecting terminal 100 is inserted into the socket 20. When the inserting portion 102 of the connecting terminal 100 is inserted into the socket 20, the second control unit 21 is in communication with the first control unit 11 to acquire a required DC charging voltage for the portable electronic device 1. Consequently, the embedded power converting device 2 outputs the DC voltage Vdc equal to the DC charging voltage based on the communication results of the second control unit 21 and the first control unit 11, and the DC voltage Vdc is conveyed to the inserting portion 102 of the connecting terminal 100 through the socket 20.

In some embodiments, the first control unit 11 and the second control unit 21 are in communication with each other by one-way mode. In other words, the first control unit 11 informs the second control unit 21 with the required DC charging voltage for the portable electronic device 1 directly. Alternatively, the first control unit 11 and the second control unit 21 are in communication with each other by two-way mode. In other words, the first control unit 11 informs the second control unit 21 with the required DC charging voltage for the portable electronic device 1, and when the outputted DC voltage Vdc is equal to the required DC charging voltage, the second control unit 21 informs the first control unit 11 so that the first control unit 11 controls the portable electronic device 1 to start the receiving of the DC voltage Vdc and enter into charging operations. Furthermore, in some embodiments, in order to implement one-way communication or two-way communication between the first control unit 11 and the second control unit 21, the first control unit 11 and the second control unit 21 include but not limited to a control integrated circuit, respectively.

Please refer to FIG. 2 again. In this embodiment, the embedded power converting device 2 further comprises a power converting circuit 22, an isolated transformer 23, plural rectifier circuits 24 and at least a selection switch 25. The power converting circuit 22 receives the input voltage Vin and converts the input voltage Vin into a transient voltage Vtr. When the input voltage Vin is the AC voltage, the power converting circuit 22 includes an AC-to-DC converter. On the contrary, when the input voltage Vin is the DC voltage, for example the DC voltage provided from a solar panel, the power converting circuit 22 includes a DC-to-DC converter.

The isolated transformer 23 comprises a primary winding Np and at least one secondary winding Ns. The primary winding Np is electrically connected with the power converting circuit 22 for receiving the transient voltage Vtr. In this embodiment, the isolated transformer 23 includes four secondary windings Ns as shown in FIG. 2. The four secondary windings Ns output respective AC induced voltages Vac through electromagnetic induction with the primary winding Np, respectively.

In some embodiments, the embedded power converting device 2 includes four rectifier circuits 24 as shown in FIG. 2. The rectifier circuits 24 are connected with respective secondary windings Ns, respectively. Each rectifier circuit 24 is used to rectify the AC induced voltage Vac to a corresponding DC voltage Vdc. In this embodiment, the embedded power converting device 2 includes two selection switches 25 as shown in FIG. 2. Each selection switch 25 comprises plural input terminals 250 and an output terminal 251. Each input terminal 250 of the selection switch 25 is electrically connected with a corresponding rectifier circuit 24, and the output terminal 251 of the selection switch 25 is electrically connected with a corresponding socket 20. The selection switch 25 switches turn-on state between one of the input terminals 250 and the output terminal 251 selectively. Consequently, the DC voltage Vdc outputted from the rectifier circuit 24 is transmitted through the path of the input terminal 250 and the output terminal 251 under the turn-on state. The DC voltage Vdc is further conveyed to the socket 20 from the output terminal 251 for providing the power to the inserting portion 102 of the connecting terminal 100 inserted inside the socket 20. In some embodiments, the rectifier circuit 24 includes but not limited to a diode and a capacitor. Alternatively, the rectifier circuit 24 is an AC-to-DC converter.

In this embodiment, the second control unit 21 is in signal communication with the selection switch 25 for controlling the operations of the selection switch 25. In other words, the second control unit 21 controls the turn-on state between the input terminals 250 and the output terminal 251 of the selection switch 25 according to the communication results with the first control unit 11. Therefore, the rectifier circuit 24 outputs the DC voltage Vdc equal to the required DC charging voltage for the portable electronic device 1 and transmits the DC voltage Vdc to the socket 20 through the corresponding input terminal 250 and the output terminal 251 under turn-on state. Thus, the DC voltage Vdc is transmitted to the socket 20 for providing the power to the inserting portion 102 of the connecting terminal 100 inserted inside the socket 20.

In this embodiment, the embedded power converting device 2 includes multiple output paths. The embedded power converting device 2 includes a primary winding Np, plural secondary windings Ns and plural rectifier circuits 24. In other words, the DC voltage Vdc outputted via each output path is generated through the primary winding Np, one of the secondary windings Ns and the corresponding rectifier circuit 24. In addition, the winding turn numbers of the secondary windings Ns are different with each other. Therefore, the voltage levels of the AC induced voltages Vac outputted from the secondary windings Ns are different with each other. As a result, the voltage levels of the DC voltages Vdc outputted from the rectifier circuits 24 are different with each other. Consequently, the selection switch 25 switches the turn-on state between the input terminals 250 and the output terminal 251 selectively and appropriately, the DC voltage Vdc equal to the required DC charging voltage of the portable electronic device 1 can be selected so as to provide power to the socket 20 and charge the portable electronic device 1. Furthermore, in other embodiment, the voltage levels of the DC voltages Vdc outputted from the rectifier circuits 24 include but not limited to 3.3V, 5V, 12V or 20V.

From the above descriptions, the embedded power converting device 2 of the power conversion system is partially embedded in the closed structure 9 and converts the input voltage Vin transmitted from the closed structure 9 into the DC voltage Vdc to charge the portable electronic device 1. Therefore, the embedded power converting device 2 doesn't need an AC power cable employed by a conventional power converting device. Consequently, the electric wire fire and electric shock can be prevented. In addition, due to that the embedded power converting device 2 is partially embedded in the closed structure 9, the electromagnetic interference produced from the embedded power converting device 2 can be suppressed by the closed structure 9. Furthermore, due to that the embedded power converting device 2 is partially embedded in the closed structure 9 but not installed in the portable electronic device 1, the volume and weight of the portable electronic device 1 can be reduced, the temperature of the portable electronic device 1 can be decreased, and the energy conversion efficiency of the portable electronic device 1 can be increased. In addition, due to that the embedded power converting device 2 is partially embedded in the closed structure 9, man-caused damage of the outward appearance and breakdown of the embedded power converting device 2 can be prevented. Therefore, the limitations and requirements on the safety regulations and electromagnetic interference specifications can be more flexible. Thus, the production cost of the power conversion system or the embedded power converting device 2 can be reduced. Furthermore, when the inserting portion 102 of the connecting terminal 100 is inserted inside the socket 20, the second control unit 21 is in communication with the first control unit 11 automatically so that the second control unit 21 can acquire the required DC charging voltage for the portable electronic device 1. Thus, the embedded power converting device 2 can output the DC voltage Vdc equal to the required DC charging voltage, and the user needn't buy various power converting devices with various output voltages or various connecting terminals.

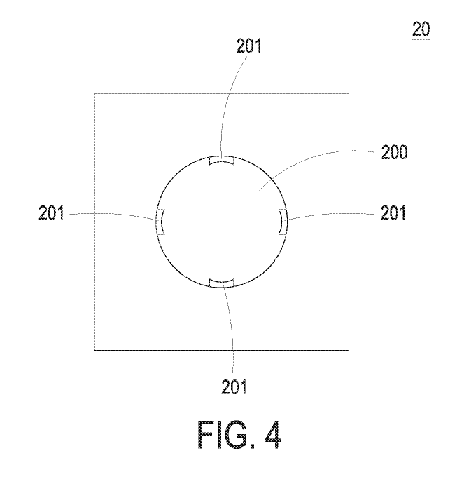

Please refer to FIGS. 1, 2, 3 and 4. FIG. 4 schematically illustrates the inner structure of a socket of FIG. 3. As shown in FIGS. 3 and 4, the inserting portion 102 of the connecting terminal 100 of the connecting cable 10 comprises a main body 103 and plural first conducting parts. For example, the plural first conducting parts include at least one first conducting part 104 and at least one first conducting part 105. The first conducting parts 104 are disposed on and surrounded around the main body 103 respectively and sequentially for transmitting power and signal. The first conducting parts 104 are disposed between the holding portion 101 and the first conducting parts 105. The first conducting part 104 includes but not limited to a power terminal for transmitting power. The first conducting part 105 includes but not limited to a signal terminal for transmitting signal.

The socket 20 comprises a receptacle 200 and plural second conducting parts 201. The inserting portion 102 of the connecting terminal 100 of the connecting cable 10 is inserted into the receptacle 200 of the socket 20. The second conducting parts 201 are disposed on and surrounded around an inner wall of the receptacle 200, and the second conducting parts 201 are spaced apart with each other. The second conducting parts 201 are electrically connected with the output terminal 251 of the selection switch 25. When the inserting portion 102 of the connecting terminal 100 is inserted inside the receptacle 200, each second conducting part 201 is partially in contact with each of the first conducting parts 104. Due to that the second conducting parts 201 are disposed on and surrounded around the inner wall of the receptacle 200 and the second conducting parts 201 are spaced apart with each other, when the inserting portion 102 of the connecting terminal 100 is inserted inside the receptacle 200, the first conducting part 104 is in contact with at least one second conducting part 201. Therefore, the direction of inserting the inserting portion 102 into the receptacle 200 isn't limited.

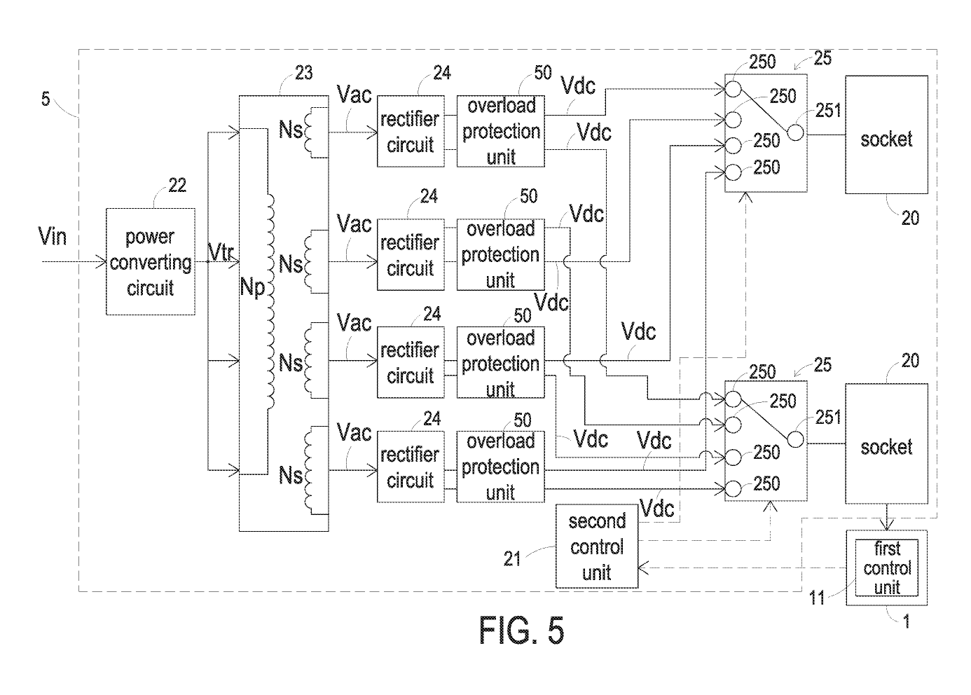

Please refer to FIG. 5. FIG. 5 is a circuit block diagram showing a portable electronic device and an embedded power converting device of a power conversion system according to a second embodiment of the present invention. As shown in FIG. 5, the structures and functions of the power conversion system are similar to those of the power conversion system as shown in FIG. 2, and are not redundantly described herein. Component parts and elements corresponding to those of the FIG. 2 are designated by identical numeral references, and detailed descriptions thereof are omitted. In comparison with the power conversion system of FIG. 2, the embedded power converting device 5 of this embodiment further comprises at least one overload protection unit 50, for example four overload protection units 50 as shown in FIG. 5. Each overload protection unit 50 is electrically connected between a corresponding rectifier circuit 24 and socket 20. The overload protection unit 50 includes at least one circuit selected from an overvoltage protection circuit, an overcurrent protection circuit, an overload protection circuit, and a short protection circuit. Therefore, the overload protection units 50 can protect the output paths of the embedded power converting device 5, respectively.

From the above descriptions, the present invention provides an embedded power converting device and a power conversion system using the same. The embedded power converting device is partially embedded in a closed structure and used to convert an input voltage transmitted from the closed structure into a DC voltage so as to charge the portable electronic device. Consequently, the electric wire fire and electric shock can be prevented, and the electromagnetic interference can be suppressed by the closed structure. In addition, due to that the embedded power converting device is partially embedded in the closed structure, the volume and weight of the portable electronic device can be reduced, the temperature of the portable electronic device can be decreased, and the energy conversion efficiency of the portable electronic device can be increased. Furthermore, due to that the embedded power converting device is partially embedded in the closed structure, man-caused damage of the outward appearance and breakdown of the embedded power converting device is prevented. Consequently, the limitations and requirements on the safety regulations and electromagnetic interference specifications can be more flexible. Thus, the cost of the power conversion system or the embedded power converting device can be reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power conversion system, comprising:
at least one portable electronic device, the portable electronic device comprising a connecting terminal and a first control unit; and
an embedded power converting device partially embedded in a closed structure, configured to convert an input voltage into a DC voltage, and comprising at least one socket and a second control unit, wherein the socket is partially exposed outside the closed structure for allowing the connecting terminal to be inserted therein, and when the connecting terminal is inserted in the socket, the second control unit is in communication with the first control unit to acquire a required DC charging voltage for the portable electronic device, and the embedded power converting device outputs a DC voltage equal to the required DC charging voltage to the connecting terminal through the socket.

2. The power conversion system according to claim 1, wherein the closed structure is a wall or a power distribution box.

3. The power conversion system according to claim 1, wherein the embedded power converting device comprises:
a power converting circuit configured to receive the input voltage and convert the input voltage to a transient voltage; and
an isolated transformer comprising a primary winding and plural secondary windings, wherein the primary winding is electrically connected with the power converting circuit for receiving the transient voltage, and the secondary windings output respective AC induced voltages with different voltage levels through an electromagnetic induction with the primary winding.

4. The power conversion system according to claim 3, wherein the embedded power converting device comprises:
plural rectifier circuits electrically connected with the respective secondary windings, respectively, wherein each rectifier circuit is configured to rectify the AC induced voltage to the DC voltage, and the voltage levels of the DC voltages outputted from the rectifier circuits are different with each.

5. The power conversion system according to claim 4, wherein the embedded power converting device comprises:
at least one selection switch comprising plural input terminals and an output terminal, wherein the input terminals are electrically connected with the respective rectifier circuits, respectively, and the output terminal is electrically connected with the socket, wherein the selection switch switches the turn-on state between the input terminals and the output terminal selectively, and the DC voltage outputted from the rectifier circuit is received by the input terminal under the turn-on state and transmitted to the connecting terminal inserted inside the socket.

6. The power conversion system according to claim 5, wherein the second control unit is electrically connected with the selection switch, and the second control unit is configured to control the turn-on state between the input terminals and the output terminal of the selection switch according to the communication results with the first control unit, so that the rectifier circuit outputs the DC voltage equal to the required DC charging voltage to the socket through the corresponding input terminal and the output terminal, and the DC voltage is provided to the connecting terminal through the socket.

7. The power conversion system according to claim 5, wherein the embedded power converting device comprises plural overload protection units electrically connected between the rectifier circuits and the socket, respectively, wherein each overload protection unit includes at least one circuit selected from an overvoltage protection circuit, an overcurrent protection circuit, an overload protection circuit and a short protection circuit.

8. The power conversion system according to claim 5, wherein the connecting terminal comprises a holding portion and an inserting portion, wherein the holding portion is made of an insulation material, and the inserting portion is connected with the holding portion.

9. The power conversion system according to claim 8, wherein the insertion portion comprises a main body and plural first conducting parts, and the first conducting parts are disposed on and surrounded around the main body respectively and sequentially.

10. The power conversion system according to claim 9, wherein the socket comprises a receptacle and plural second conducting parts, wherein the inserting portion is inserted into the receptacle, the second conducting parts are disposed on and surrounded around an inner wall of the receptacle and spaced apart with each other, and the second conducting parts are electrically connected with the output terminal of the selection switch, wherein when the inserting portion is inserted inside the receptacle, the second conducting part is partially in contact with each of the first conducting parts.

11. An embedded power converting device, partially embedded in a closed structure and configured to convert an input voltage into a DC voltage, the embedded power converting device comprising:
at least one socket partially exposed outside the closed structure for allowing a connecting terminal of a portable electronic device to be inserted therein; and
a second control unit, wherein when the connecting terminal is inserted in the socket, the second control unit is in communication with a first control unit of the portable electronic device to acquire a required DC charging voltage for the portable electronic device, and the embedded power converting device outputs a DC voltage equal to the required DC charging voltage to the connecting terminal through the socket.

12. The embedded power converting device according to claim 11, further comprising:
a power converting circuit configured to receive the input voltage and convert the input voltage to a transient voltage; and
an isolated transformer comprising a primary winding and plural secondary windings, wherein the primary winding is electrically connected with the power converting circuit for receiving the transient voltage, and the secondary windings output respective AC induced voltages with different voltage levels through an electromagnetic induction with the primary winding.

13. The embedded power converting device according to claim 12, further comprising:
plural rectifier circuits electrically connected with the respective secondary winding, respectively, wherein each rectifier circuit is configured to rectify the AC induced voltage to the DC voltage, and the voltage levels of the DC voltages outputted from the rectifier circuits are different with each.

14. The embedded power converting device according to claim 13, further comprising:
at least one selection switch comprising plural input terminals and an output terminal, wherein the input terminals are electrically connected with the rectifier circuits, respectively, and the output terminal is electrically connected with the socket, wherein the selection switch switches the turn-on state between the input terminals and the output terminal selectively, and the DC voltage outputted from the rectifier circuit is received by the input terminal under the turn-on state and transmitted to the connecting terminal inserted inside the socket.
